(19) United States
(12) Patent Application Publication
(10) Pub. No.: US 2024/0356012 A1
(43) Pub. Date: Oct. 24, 2024

(54) ELECTROCHEMICAL DEVICE AND ELECTRONIC DEVICE CONTAINING SAME

(71) Applicant: Ningde Amperex Technology Limited, Ningde, Fujian (CN)

(72) Inventors: Bing JIANG, Ningde (CN); Feng ZHOU, Ningde (CN); Qingwen ZHANG, Ningde (CN)

(73) Assignee: Ningde Amperex Technology Limited, Ningde, Fujian (CN)

(21) Appl. No.: 18/758,271

(22) Filed: Jun. 28, 2024

Related U.S. Application Data
(63) Continuation of application No. PCT/CN2021/142989, filed on Dec. 30, 2021.

(51) Int. Cl. H01M 4/36; H01M 4/02; H01M 4/04; H01M 4/583; H01M 10/0525

(52) U.S. Cl. CPC H01M 4/366; H01M 4/0416; H01M 4/583; H01M 10/0525; H01M 2004/021; H01M 2004/027

(57) ABSTRACT

An electrochemical device includes a negative electrode. The negative electrode includes a negative current collector and a negative active material layer disposed on at least one surface of the negative current collector. In an infrared spectroscopy test, the negative active material layer exhibits at least a first peak and a second peak in a wavenumber range of 2500 cm⁻¹ to 3200 cm⁻¹. This indicates that the negative active material layer contains an additive, and the additive increases the production efficiency of the negative electrode, thereby increasing the production efficiency of the electrochemical device. In addition, the electrochemical device exhibits a high discharge capacity.

### CROSS-REFERENCE TO RELATED APPLICATION

This application is a continuation of International Patent Application No. PCT/CN2021/142989, filed on Dec. 30, 2021, the disclosure of which is hereby incorporated by reference in its entirety.

### TECHNICAL FIELD

This application relates to the electrochemical field, and in particular, to an electrochemical device and an electronic device containing same.

### BACKGROUND

As a new type of mobile energy storage device, electrochemical devices, such as a lithium-ion battery, are increasingly required in the field of portable small electronic devices such as a mobile phone, a laptop computer, and a video camera and in the fields of large electric transport vehicles and renewable energy storage equipment by virtue of a high energy density, a high working voltage, a long cycle life, no memory effect, environment-friendliness, and other advantages. To meet the market demand, manufacturers need to maximally improve the production efficiency of lithium-ion batteries.

An effective method for improving the production efficiency of lithium-ion batteries is to increase the coating speed of electrodes (positive and/or negative electrodes). However, this method is usually accompanied by an increase in the temperature of the oven for drying the electrode plate, and an increase in the wobbling of the electrode plate during the coating of an active material, thereby leading to cracking of an active material layer of the electrode plate, and resulting in substandard quality of the electrode plate and an increase in the production cost. Solving the above problem by reducing the coating weight of the active material layer will lead to a decrease in a discharge capacity of the lithium-ion battery. Therefore, how to improve the production efficiency of the lithium-ion batteries without impairing the discharge capacity of the lithium-ion batteries has become a pressing challenge to persons skilled in the art.

### SUMMARY

This application provides an electrochemical device and an electronic device containing the electrochemical device. An objective of this application is to increase the production efficiency of the electrochemical device while endowing the electrochemical device with a high discharge capacity.

It is hereby noted that in the subject-matter hereof, this application is construed by using a lithium-ion battery as an example of an electrochemical device, but the electrochemical device according to this application is not limited to the lithium-ion battery. Specific technical solutions are as follows:

According to a first aspect, this application provides an electrochemical device. The electrochemical device includes a negative electrode. The negative electrode includes a negative current collector and a negative active material layer disposed on at least one surface of the negative current collector. In an infrared spectroscopy test, the negative active material layer exhibits at least a first peak and a second peak in a wavenumber range of 2500 cm⁻¹ to 3200 cm⁻¹. This increases the production efficiency of the electrochemical device while endowing the electrochemical device with a high discharge capacity.

In an embodiment of this application, the first peak corresponds to a wavenumber k₁ falling within a range of 2800 cm⁻¹≤k₁≤2900 cm⁻¹, the second peak corresponds to a wavenumber k₂ falling within a range of 2900 cm⁻¹≤k₂≤3000 cm⁻¹, and an intensity ε₁ of the first peak and an intensity ε₂ of the second peak satisfy: 0.9≤ε₁/ε₂≤1.0. This increases the production efficiency of the electrochemical device while endowing the electrochemical device with a high discharge capacity.

In an embodiment of this application, the negative active material layer includes an additive. The additive includes at least one of stearic acid, stearamide, magnesium stearate, calcium stearate, sodium stearate, lithium stearate, zinc stearate, aluminum stearate, chromium stearate, or barium stearate. The negative active material layer includes the above types of additives, and the additives help to achieve high production efficiency of the electrochemical device while endowing the electrochemical device with a high discharge capacity.

In an embodiment of this application, based on a mass of the negative active material layer, a mass percent W₁% of the additive is 0.05% to 5%. By controlling the mass percent W₁% of the additive to fall within the above range, this application effectively increases the production efficiency of the electrochemical device while endowing the electrochemical device with a high discharge capacity.

In an embodiment of this application, the negative active material layer includes a metal element. The metal element includes at least one of Mg, Al, Co, Ti, Cr, Y, W, or Ca. With the negative active material layer containing the above types of metal elements, the production efficiency of the electrochemical device can be improved, and the discharge capacity of the electrochemical device can be further improved.

In an embodiment of this application, based on a mass of the negative active material layer, a content of the metal element is M ppm, satisfying: M≤300. By controlling the content of the metal element to fall within the above range, the discharge capacity of the electrochemical device is further improved on the basis of achieving a relatively high production efficiency of the electrochemical device. In an embodiment of this application, the metal element includes Al. Based on a mass of the negative active material layer, a content of Al is M₁ ppm, satisfying: 10≤M₁≤90. By controlling the content of Al to fall within the above range, this application further improves the discharge capacity of the electrochemical device while achieving a relatively high production efficiency of the electrochemical device.

In an embodiment of this application, the metal element includes Co. Based on a mass of the negative active material layer, a content of Co is M₂ ppm, satisfying: 0.5≤M₂≤20. By controlling the content of Co to fall within the above range, the discharge capacity of the electrochemical device is further improved on the basis of achieving a relatively high production efficiency of the electrochemical device.

In an embodiment of this application, the metal element includes Cr. Based on a mass of the negative active material layer, a content of Cr is M₃ ppm, satisfying: 0≤M₃≤5. By controlling the content of Cr to fall within the above range, this application further improves the discharge capacity of the electrochemical device while achieving a relatively high production efficiency of the electrochemical device.

In an embodiment of this application, the metal element includes Al and Co. Based on a mass of the negative active material layer, a content of Al is M₁ ppm, and a content of Co is M₂ ppm, satisfying: 5≤M₁/M₂≤60, and 1≤M₂≤20. By controlling the content of Al and the content of Co to fall within the above ranges, this application exerts a synergistic effect between Al and Co, thereby further improving the discharge capacity of the electrochemical device while achieving a relatively high production efficiency of the electrochemical device.

In an embodiment of this application, the metal element includes Al and Cr. Based on a mass of the negative active material layer, a content of Al is M₁ ppm, and a content of Cr is M₃ ppm, satisfying: 30≤M₁/M₃≤100. By controlling the ratio between the content of Al and the content of Cr to fall within the above range, this application exerts a synergistic effect between Al and Cr, thereby further improving the discharge capacity of the electrochemical device while achieving a relatively high production efficiency of the electrochemical device.

In an embodiment of this application, the negative active material layer further includes a dispersant. The dispersant includes at least one of lithium hydroxymethyl cellulose, sodium hydroxymethyl cellulose, polyacrylic acid, or sodium polyacrylate. Based on a mass of the negative active material layer, a mass percent W₂% of the dispersant and a mass percent W₁% of the additive satisfy: 0≤W₂−W₁≤3. The above types of dispersants selected give full play to the role of each constituent in the negative active material layer, and improve the electrochemical performance of the electrochemical device. By controlling the difference between the mass percent W₂% of the dispersant and the mass percent W₁% of the additive to fall within the above ranges, this application improves the production efficiency of the electrochemical device while endowing the electrochemical device with a high energy density and other good electrochemical performance metrics.

According to an embodiment of this application, a porosity α of the negative active material layer is 15% to 60%. The porosity α controlled to fall within the above range can enhance the kinetic performance of the electrochemical device.

In an embodiment of this application, an areal density of the negative active material layer on a single side is 0.02 mg/mm² to 0.4 mg/mm². Controlling the areal density of the negative active material layer on a single side to fall within the above range can improve the discharge capacity and production efficiency of the electrochemical device.

In an embodiment of this application, in a thermogravimetric analysis, a weight loss percentage of the negative active material layer in a temperature range of 400° C. to 800° C. is W_{T}%, satisfying: W_{T}≤1. This indicates that the negative active material layer is of high thermal stability in a temperature range of 400° C. to 800° C., thereby further improving the discharge capacity of the electrochemical device.

In an embodiment of this application, the negative active material layer further includes a negative active material. The negative active material includes at least one of graphite, hard carbon, silicon, or a silicon-oxygen material. The above types of negative active materials selected can further improve the discharge capacity of the electrochemical device.

In an embodiment of this application, a number of cracks in any region of 20 cm×40 cm in size selected on the negative active material layer is less than or equal to 2. This indicates that the production efficiency of the electrochemical device is high on the basis of achieving a high discharge capacity.

In an embodiment of this application, a tensile strength of the negative electrode is 300 MPa to 600 MPa, indicating that the negative electrode exhibits good tensile properties. In this way, the number of cracks on the negative electrode can be further reduced, the production capacity of the negative electrodes is increased, and the production efficiency of the electrochemical device is improved.

According to a second aspect, this application provides an electronic device. The electronic device includes the electrochemical device according to the first aspect of this application.

This application provides an electrochemical device and an electronic device containing the electrochemical device. The electrochemical device includes a negative electrode. The negative electrode includes a negative current collector and a negative active material layer disposed on at least one surface of the negative current collector. In an infrared spectroscopy test, the negative active material layer exhibits at least a first peak and a second peak in a wavenumber range of 2500 cm⁻¹ to 3200 cm⁻¹. This indicates that the negative active material layer contains a substance such as an additive capable of improving the performance of the negative active material layer, and the substance increases the production efficiency of the negative electrode, thereby increasing the production efficiency of the electrochemical device. In addition, the electrochemical device exhibits a high discharge capacity.

### BRIEF DESCRIPTION OF THE DRAWINGS

To describe the technical solutions in this application or the prior art more clearly, the following outlines the drawings to be used in the embodiments of this application or the prior art. Evidently, the drawings outlined below are merely a part of embodiments of this application.

FIGURE shows an infrared spectrogram according to Embodiment 2-1 of this application.

### DETAILED DESCRIPTION

To make the objectives, technical solutions and advantages of this application clearer, the following describes this application in further detail with reference to drawings and embodiments. Evidently, the described embodiments are merely a part of but not all of the embodiments of this application. All other embodiments derived by a person of ordinary skill in the art based on the embodiments of this application without making any creative efforts still fall within the protection scope of this application.

It is hereby noted that in specific embodiments of this application, this application is construed by using a lithium-ion battery as an example of the electrochemical device, but the electrochemical device according to this application is not limited to the lithium-ion battery.

According to a first aspect, this application provides an electrochemical device. The electrochemical device includes a negative electrode. The negative electrode includes a negative current collector and a negative active material layer disposed on at least one surface of the negative current collector. In an infrared spectroscopy test, the negative active material layer exhibits at least a first peak and a second peak in a wavenumber range of 2500 cm⁻¹ to 3200 cm⁻¹. When the negative active material layer exhibits at least a first peak and a second peak in a wavenumber range of 2500 cm⁻¹ to 3200 cm⁻¹, the infrared spectroscopy test indicates that the negative active material layer contains a substance such as an additive capable of improving the performance of the negative active material layer. Specifically, on the one hand, a substance such as an additive capable of improving the performance of the negative active material layer exists in the negative active material layer, and can improve the plasticizing effect of the negative active material layer, thereby endowing the negative active material layer with high flexibility, reducing the risk of cracking of the negative active material layer during baking of the negative electrode, and improving the production efficiency of the negative electrode. On the other hand, the existence of the additive in the negative active material layer is conducive to reducing a contact angle between a negative electrode slurry and a negative current collector, so as to improve the infiltration effect of the negative electrode slurry. In this way, the distribution of the negative electrode slurry on the negative current collector is more uniform. During baking of the negative electrode, the moisture in the negative active material layer can evaporate faster and more uniformly. As a result, the negative electrode can be dried quickly while reducing the risk of cracking the negative active material layer caused by nonuniform stress inside the negative electrode, and the coating speed of the negative active material layer is increased effectively. This reduces the loss of the discharge capacity of the electrochemical device brought about by the decline in the coating weight of the negative active material layer, and reduces the risk of a decline in the production efficiency of the electrochemical device brought about by the decrease in the coating speed of the negative active material layer. In this application, the contact angle between the negative electrode slurry and the negative current collector is less than or equal to 60°, indicating that the negative electrode is well infiltrated.

Overall, in an infrared spectroscopy test, when the negative active material layer contains a substance that exhibits at least a first peak and a second peak in a wavenumber range of 2500 cm⁻¹ to 3200 cm⁻¹, the production efficiency of the electrochemical device is improved while endowing the electrochemical device with a high discharge capacity.

In an embodiment of this application, the first peak corresponds to a wavenumber k₁ falling within a range of 2800 cm⁻¹≤k₁≤2900 cm⁻¹, and the second peak corresponds to a wavenumber k₂ falling within a range of 2900 cm⁻¹≤k₂≤3000 cm⁻¹. An intensity ε₁ of the first peak and an intensity ε₂ of the second peak satisfy: 0.9≤ε₁/ε₂≤1.0. For example, the value of the ε₁/ε₂ ratio is 0.9, 0.91, 0.92, 0.93, 0.94, 0.95, 0.96, 0.97, 0.98, 0.99, 1.0, or a value falling within a range formed by any two thereof. When the intensity ε₁ of the first peak and the intensity ε₂ of the second peak satisfy the above relationship, the difference between the intensity ε₁ of the first peak and the intensity ε₂ of the second peak is relatively small, indicating that a degree of surface substitution of the substance capable of improving the performance of the negative active material layer falls within a desirable range. In this case, the structure of the substance is relatively stable and not easily decomposable, and can still maintain inherent properties even at high temperature, thereby improving the production efficiency of the electrochemical device while endowing the electrochemical device with a high discharge capacity.

The intensity ε₁ of the first peak and the intensity ε₂ of the second peak are not particularly limited herein, as long as the objectives of this application can be achieved.

In an embodiment of this application, the negative active material layer includes an additive. The additive includes at least one of stearic acid, stearamide, magnesium stearate, calcium stearate, sodium stearate, lithium stearate, zinc stearate, aluminum stearate, chromium stearate, or barium stearate. The negative active material layer that includes the above types of additives more favorably improves the plasticizing effect of the negative active material layer, reduces the risk of cracking of the negative active material layer, and improves the production efficiency of the negative electrode. In addition, during baking of the negative electrode, the moisture in the negative active material layer can evaporate faster and more uniformly. As a result, the negative electrode can be dried quickly while reducing the risk of cracking the negative active material layer caused by nonuniform stress inside the negative electrode, and the coating speed of the negative active material layer is increased effectively, thereby improving the production efficiency of the negative electrode. This effectively increases the production efficiency of the electrochemical device while endowing the electrochemical device with a high discharge capacity.

In an embodiment of this application, based on a mass of the negative active material layer, a mass percent W₁% of the additive is 0.05% to 5%. For example, the mass percent W₁% of the additive is 0.05%, 0.1%, 0.2%, 0.3%, 0.5%, 1%, 1.5%, 2%, 2.5%, 3%, 3.5%, 4%, 4.5%, 5%, or a value falling within a range formed by any two thereof. When the mass percent W₁% of the additive is overly low (for example, lower than 0.05%), the improvement effect on the production efficiency of the electrochemical device is not significant. With the increase of the mass percent W₁% of the additive, the improvement effect on the production efficiency of the electrochemical device increases favorably. When the mass percent W₁% of the additive is overly high (for example, higher than 5%), the improvement effect of the additive on the production efficiency of the electrochemical device stops increasing significantly, and the discharge capacity of the electrochemical device is impaired because the additive occupies an excessive proportion of the negative active material. Therefore, by controlling the mass percent W₁% of the additive to fall within the above range, this application effectively increases the production efficiency of the electrochemical device while endowing the electrochemical device with a high discharge capacity.

In an embodiment of this application, based on a mass of the negative active material layer, a mass percent W₁% of the additive is 0.1% to 1%. When the mass percent of the additive falls within this range, the electrochemical device exhibits higher overall performance.

In an embodiment of this application, the negative active material layer includes a metal element. The metal element includes at least one of Mg, Al, Co, Ti, Cr, Y, W, or Ca. The negative active material layer that includes the above types of metal elements can improve the lithiation performance of the negative electrode, thereby compensating for the loss of the discharge capacity of the electrochemical device caused by the fact that the additive occupies a proportion of the negative active material. In this way, the production efficiency of the electrochemical device is improved, and the discharge capacity of the electrochemical device is further improved.

In an embodiment of this application, based on a mass of the negative active material layer, a content of the metal element is M ppm, satisfying: M≤300. Preferably, 0.01≤M≤200. For example, the content of the metal element is 0.01 ppm, 1 ppm, 2 ppm, 5 ppm, 10 ppm, 20 ppm, 30 ppm, 50 ppm, 90 ppm, 150 ppm, 200 ppm, 250 ppm, 300 ppm, or a value falling within a range formed by any two thereof. When the content of the metal element is overly high, complexation of metal ions is prone to occur during the preparation of a negative electrode slurry, thereby affecting gelation of the negative electrode slurry, and in turn, adversely affecting the production. By controlling the content of the metal element to fall within the above range, the discharge capacity of the electrochemical device is further improved on the basis of achieving a relatively high production efficiency of the electrochemical device.

In an embodiment of this application, based on the mass of the negative active material layer, the content of the metal element is M ppm, satisfying: 0.01≤M≤200. When the mass percent of the metal element falls within this range, the electrochemical device exhibits higher overall performance.

In an embodiment of this application, the metal element includes Al. Based on a mass of the negative active material layer, a content of Al is M₁ ppm, satisfying: 10≤M₁≤90. For example, the content of the Al is 10 ppm, 20 ppm, 30 ppm, 40 ppm, 50 ppm, 60 ppm, 70 ppm, 80 ppm, 90 ppm, or a value falling within a range formed by any two thereof. The metal elements that include Al can further improve the lithiation performance of the negative electrode, thereby improving the discharge capacity of the electrochemical device. In view of the conductive properties of Al, the applicant hereof finds through extensive research that, if the content of Al is overly low (for example, lower than 10 ppm), the effect of the aluminum in improving the lithiation performance of the negative electrode is not significant. If the content of Al is overly high (for example, higher than 90 ppm), side reactions may occur at the negative electrode in large quantities, thereby impairing the first-cycle Coulombic efficiency of the electrochemical device. By controlling the content of Al to fall within the above range, this application further improves the discharge capacity of the electrochemical device while achieving a relatively high production efficiency of the electrochemical device.

In an embodiment of this application, the metal element includes Co. Based on a mass of the negative active material layer, a content of Co is M₂ ppm, satisfying: 0.5≤M₂≤20. For example, the content of Co is 0.5 ppm, 1 ppm, 2 ppm, 4 ppm, 6 ppm, 8 ppm, 10 ppm, 15 ppm, 20 ppm, or a value falling within a range formed by any two thereof. The metal elements that include Co can further improve the lithiation performance of the negative electrode, thereby improving the discharge capacity of the electrochemical device. In view of the conductive properties of Co, the applicant hereof finds through extensive research that, if the content of Co is overly low (for example, lower than 0.5 ppm), the effect of the cobalt in improving the lithiation performance of the negative electrode is not significant. If the content of Co is overly high (for example, higher than 20 ppm), the cobalt may complex with the dispersant in the slurry to affect dispersion of the dispersant, thereby affecting the production of the slurry. By controlling the content of Co to fall within the above range, the discharge capacity of the electrochemical device is further improved on the basis of achieving a relatively high production efficiency of the electrochemical device.

In an embodiment of this application, the metal element includes Cr. Based on a mass of the negative active material layer, a content of Cr is M₃ ppm, satisfying: 0≤M₃≤5. For example, the content of Cr is 0.01 ppm, 1 ppm, 2 ppm, 3 ppm, 4 ppm, 5 ppm, or a value falling within a range formed by any two thereof. The metal elements that include Cr can further improve the lithiation performance of the negative electrode, thereby improving the discharge capacity of the electrochemical device. In view of the conductive properties of Cr, even a small amount of Cr included in the negative active material layer can improve the lithiation performance of the negative electrode. With the content of Cr increases to an excessive level (for example, higher than 10 ppm), the Cr impairs the overall performance of the negative electrode slurry, and is unfavorable to improving the production efficiency. By controlling the content of Cr to fall within the above range, this application further improves the discharge capacity of the electrochemical device while achieving a relatively high production efficiency of the electrochemical device.

In an embodiment of this application, the metal element includes Al and Co. Based on a mass of the negative active material layer, a content of Al is M₁ ppm, and a content of Co is M₂ ppm, satisfying: 5≤M₁/M₂≤60, and 1≤M₂≤20. For example, the value of the M₁/M₂ ratio is 5, 10, 20, 30, 40, 50, 60, or a value falling within a range formed by any two thereof. The content of Co is 1 ppm, 2 ppm, 3 ppm, 4 ppm, 5 ppm, 6 ppm, 7 ppm, 8 ppm, 9 ppm, 10 ppm, or a value falling within a range formed by any two thereof. By controlling the content of Al and the content of Co to fall within the above ranges, this application exerts a synergistic effect between Al and Co, thereby further improving the discharge capacity of the electrochemical device while achieving a relatively high production efficiency of the electrochemical device. It is hereby noted that in this embodiment, the content of Al is not particularly limited, as long as the M₁/M₂ ratio satisfies the above value range.

In an embodiment of this application, the metal element includes Al and Cr. Based on a mass of the negative active material layer, a content of Al is M₁ ppm, and a content of Cr is M₃ ppm, satisfying: 30≤M₁/M₃≤100. The value of the M₁/M₃ ratio is 30, 40, 50, 60, 70, 80, 90, 100, or a value falling within a range formed by any two thereof. By controlling the ratio between the content of Al and the content of Cr to fall within the above range, this application exerts a synergistic effect between Al and Cr, thereby further improving the discharge capacity of the electrochemical device while achieving a relatively high production efficiency of the electrochemical device.

It is hereby noted that in this embodiment, the content of Al and the content of Cr are not particularly limited, as long as the M₁/M₃ ratio satisfies the above value range.

In an embodiment of this application, the metal element in the negative active material layer may be introduced during the production of the additive, or some of the metal ions in the positive active material may be freed to the negative active material layer during charging and discharging.

In an embodiment of this application, the negative active material layer further includes a dispersant. The dispersant includes at least one of lithium hydroxymethyl cellulose, sodium hydroxymethyl cellulose, polyacrylic acid, or sodium polyacrylate. Based on a mass of the negative active material layer, a mass percent W₂% of the dispersant and a mass percent W₁% of the additive satisfy: 0≤W₂−W₁≤3. The above types of dispersants selected can prevent the sedimentation and coalescence of the particles of different constituents in the negative active material slurry, and disperse the particles of different constituents uniformly in the negative active material layer, thereby giving full play to the role of each constituent in the negative active material layer, and improving the electrochemical performance of the electrochemical device. By controlling the difference between the mass percent W₂% of the dispersant and the mass percent W₁% of the additive to fall within the above ranges, the additive and the dispersant are caused to work synergistically, thereby reducing the risk of cracking the negative active material layer while giving full play to each constituent in the negative active material layer, and in turn, improving the production efficiency of the electrochemical device while endowing the electrochemical device with a high energy density and other good electrochemical performance metrics. In this application, the mass percent W₂ of the dispersant is not particularly limited herein, as long as the objectives of this application can be achieved. For example, the mass percent W₂% of the dispersant is 0.3% to 5%.

According to an embodiment of this application, the porosity α of the negative active material layer is 15% to 60%. For example, the porosity α is 15%, 20%, 30%, 40%, 50%, 60%, or a value falling within a range formed by any two thereof. With the porosity α is controlled to fall within the above range, the failure of contact between the particles of the negative active material can be suppressed during the charge-discharge cycles of the electrochemical device, where the failure of contact leads to a decline in the cycle performance and energy density of the electrochemical device. At the same time, the porosity falling within the specified range ensures that the negative active material is sufficiently infiltrated by the electrolyte solution, reduces the transmission distance of lithium ions, and improves the kinetic performance such as low-temperature discharge performance of the electrochemical device. In this application, the porosity α of the negative active material layer means a percentage of the volume of pores between various constituents in the negative active material layer to an apparent volume of the negative active material layer. The porosity of the negative active material layer may be controlled by controlling the drying temperature, the cold-pressing time, the coating weight, or the cold-pressing force during the preparation of the negative electrode.

According to an embodiment of this application, the porosity α of the negative active material layer is 20% to 40%. When the porosity α of the negative active material layer falls within this range, the electrochemical device exhibits higher overall performance.

In an embodiment of this application, an areal density of the negative active material layer on a single side is 0.02 mg/mm² to 0.4 mg/mm². For example, the areal density of the negative active material layer on a single side is 0.02 mg/mm², 0.13 mg/mm², 0.3 mg/mm², 0.4 mg/mm², or a value falling within a range formed by any two thereof. When the areal density of the negative active material layer on a single side is overly low (for example, lower than 0.02 mg/mm²), the concentration of the negative active material is overly low, and may impair the discharge capacity of the electrochemical device. The additive added in the negative active material layer makes the areal density of the negative active material layer higher than that in the prior art, thereby further increasing the discharge capacity of the electrochemical device. However, when the areal density of the negative active material layer on a single side is overly high (for example, higher than 0.4 mg/mm²), the thickness of the negative active material layer will be excessive, thereby increasing the size of the electrochemical device, and impairing the energy density of the electrochemical device. In addition, the excessive thickness of the negative active material layer increases the baking time for the negative electrode, thereby reducing the production efficiency of the electrochemical device or increasing the cracks of the negative electrode. In addition, this deteriorates the performance of the electrolyte solution in infiltrating the negative active material layer, and is unfavorable to improving the overall performance of the electrochemical device. Controlling the areal density of the negative active material layer on a single side to fall within the above range can improve the discharge capacity and production efficiency of the electrochemical device.

In an embodiment of this application, in a thermogravimetric analysis, a weight loss percentage of the negative active material layer in a temperature range of 400° C. to 800° C. is W_{T}%, satisfying: W_{T}≤1. This indicates that the negative active material layer is of high thermal stability in a temperature range of 400° C. to 800° C., thereby further improving the discharge capacity of the electrochemical device.

In an embodiment of this application, the negative active material layer further includes a negative active material. The negative active material includes at least one of graphite, hard carbon, silicon, or a silicon-oxygen material. The above types of negative active materials selected can further improve the discharge capacity of the electrochemical device.

In an embodiment of this application, a number of cracks in any region of 20 cm×40 cm in size selected on the negative active material layer is less than or equal to 2. This indicates that the electrochemical device achieves a high discharge capacity, the number of cracks on the negative active material layer manufactured at a relatively high production efficiency is relatively small, the negative electrode is of high quality, the scrap rate of the negative electrodes is reduced, and the production capacity is increased, thereby further improving the production efficiency of the electrochemical device. The term “crack” used herein means a gap of a length greater than 2 cm that appears on the negative active material layer.

In an embodiment of this application, a tensile strength of the negative electrode is 300 MPa to 600 MPa, indicating that the negative electrode exhibits good tensile properties. In this way, the number of cracks on the negative electrode can be further reduced, the production capacity of the negative electrodes is increased, and the production efficiency of the electrochemical device is improved.

The negative current collector is not particularly limited in this application, as long as the objectives of this application can be achieved. For example, the negative current collector may be copper foil, copper alloy foil, nickel foil, stainless steel foil, titanium foil, foamed nickel, foamed copper, a composite current collector, or the like. The thicknesses of the negative current collector and the negative active material layer are not particularly limited herein, as long as the objectives of this application can be achieved. For example, the thickness of the negative current collector is 6 μm to 10 μm, and the thickness of the negative active material layer on a single side of the current collector is 30 μm to 130 μm. In this application, the negative active material layer may be disposed on one surface of the negative current collector in the thickness direction or on both surfaces of the negative current collector in the thickness direction. It is hereby noted that the “surface” here may be the entire region of the negative current collector, or a partial region of the negative current collector, without being particularly limited in this application, as long as the objectives of the application can be achieved. Optionally, the negative electrode may further include a conductive layer. The conductive layer is located between the negative current collector and the negative active material layer. The constituents of the conductive layer are not particularly limited herein, and the conductive layer may be a conductive layer commonly used in the art. For example, the conductive layer includes a conductive agent and a binder.

The electrochemical device of this application further includes a positive electrode. The positive electrode is not particularly limited herein, as long as the objectives of this application can be achieved. For example, the positive electrode includes a positive current collector and a positive active material layer. The positive current collector is not particularly limited in this application, as long as the objectives of this application can be achieved. For example, the positive current collector may include aluminum foil, aluminum alloy foil, a composite current collector, or the like. The positive active material layer in this application includes a positive active material. The type of the positive active material is not particularly limited in this application, as long as the objectives of this application can be achieved. For example, the positive active material may include at least one of lithium nickel cobalt manganese oxide (811, 622, 523, 111), lithium nickel cobalt aluminum oxide, lithium iron phosphate, a lithium-rich manganese-based material, lithium cobalt oxide (LiCoO₂), lithium manganese oxide, lithium manganese iron phosphate, lithium titanium oxide, or the like. In this application, the positive active material may further include a non-metallic element. For example, the non-metallic elements include at least one of fluorine, phosphorus, boron, chlorine, silicon, or sulfur. Such elements can further improve the stability of the positive active material. In this application, the thicknesses of the positive current collector and the positive active material layer are not particularly limited, as long as the objectives of this application can be achieved. For example, the thickness of the positive current collector is 5 μm to 20 μm, and preferably 6 μm to 18 μm. The thickness of the positive active material layer on a single side is 30 μm to 120 μm. In this application, the positive active material layer may be disposed on one surface of the positive current collector in a thickness direction or on both surfaces of the positive current collector in the thickness direction. It is hereby noted that the “surface” here may be the entire region of the positive current collector, or a partial region of the positive current collector, without being particularly limited herein, as long as the objectives of the application can be achieved. Optionally, the positive electrode may further include a conductive layer. The conductive layer is located between the positive current collector and the positive active material layer. The composition of the conductive layer is not particularly limited, and may be a conductive layer commonly used in the art. The conductive layer includes a conductive agent and a binder.

The conductive agent and the binder are not particularly limited herein, as long as the objectives of this application can be achieved. For example, the conductive agent may include at least one of conductive carbon black (Super P), carbon nanotubes (CNTs), carbon nanofibers, flake graphite, acetylene black, carbon dots, or graphene. For example, the binder may include at least one of polypropylene alcohol, sodium polyacrylate, potassium polyacrylate, lithium polyacrylate, polyimide, styrene-butadiene rubber (SBR), polyvinyl alcohol (PVA), polyvinylidene fluoride, polyvinylidene difluoride (PVDF), polytetrafluoroethylene (PTFE), polyvinyl butyral (PVB), water-based acrylic resin, carboxymethyl cellulose (CMC), or sodium carboxymethyl cellulose (CMC-Na).

It is hereby noted that in this application, unless otherwise expressly specified, the negative active material layer means a negative active material layer on a single side, and the positive active material layer means a positive active material layer on a single side.

The electrochemical device according to this application further includes an electrolytic solution. The type of the electrolytic solution is not particularly limited in this application, as long as the objectives of this application can be achieved. For example, the electrolyte solution may be prepared by mixing at least one of ethylene carbonate (EC), propylene carbonate (PC), diethyl carbonate (DEC), ethyl propionate (EP), ethyl methyl carbonate (EMC), dimethyl carbonate (DMC), fluoroethylene carbonate (FEC), or the like at a specified mass ratio to obtain an organic solution, and then adding a lithium salt in the organic solution to dissolve, and stirring well. The type of the lithium salt is not particularly limited herein, as long as the objectives of this application can be achieved. For example, the lithium salt may include at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. Preferably, the lithium salt may be LiPF₆ because it provides a high ionic conductivity and improves cycle characteristics.

The electrochemical device of this application further includes a separator. The separator is configured to separate the positive electrode (also referred to as positive electrode plate) from the negative electrode (also referred to as negative electrode plate) to prevent an internal short circuit of the electrochemical device and allow free passage of electrolyte ions, so as to implement electrochemical charging and discharging processes. The separator is not particularly limited herein, as long as the objectives of this application can be achieved.

The electrochemical device in this application is not particularly limited, and may be any device in which an electrochemical reaction occurs. In some embodiments, the electrochemical device may include, but not limited to, a lithium metal secondary battery, a lithium-ion battery, a lithium polymer secondary battery, a lithium-ion polymer secondary battery, or the like.

The process of preparing the electrochemical device is well known to a person skilled in the art, and is not particularly limited herein. For example, the preparation process may include, but without being limited to, the following steps: stacking the positive electrode, the separator, and the negative electrode in sequence, and performing operations such as winding and folding as required to obtain a jelly-roll electrode assembly; putting the electrode assembly into a packaging shell, injecting the electrolyte solution into the packaging shell, and sealing the packaging shell to obtain an electrochemical device; or, stacking the positive electrode, the separator, and the negative electrode in sequence, and then fixing the four corners of the entire stacked structure by use of adhesive tape to obtain a stacked-type electrode assembly, putting the electrode assembly into a packaging shell, injecting the electrolyte solution into the packaging shell, and sealing the packaging shell to obtain an electrochemical device. In addition, an overcurrent prevention element, a guide plate, and the like may be placed into the packaging shell as required, so as to prevent the rise of internal pressure, overcharge, and overdischarge of the electrochemical device.

A second aspect of this application provides an electronic device. The electronic device includes the electrochemical device according to any one of the preceding embodiments of this application. The electronic device exhibits a high discharge capacity and a relatively high production efficiency.

The electronic devices of this application are not particularly limited, and may include, but are not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, and the like.

### EMBODIMENTS

The implementations of this application are described below in more detail with reference to embodiments and comparative embodiments. Various tests and evaluations are performed by the following methods.

### Test Methods and Devices

### Infrared Spectroscopy Test

Discharging a lithium-ion battery until the voltage reaches 2.8 V, disassembling the battery to obtain a negative electrode, oven-drying the negative electrode, scraping off a negative active material layer from the negative electrode, and soaking the negative active material layer in tetrahydrofuran for 24 h, and then centrifuging the solution, and pouring out the centrifuged solution into a 70° C. environment to evaporate until all the tetrahydrofuran has evaporated. Retaining the residual liquid, and then testing the residual liquid by using an FTIR-1500 Fourier transform infrared spectrometer.

### Testing the Content of Each Metal Element in the Negative Active Material Layer

Discharging a lithium-ion battery until the voltage reaches 2.8 V, disassembling the battery to obtain a negative electrode, and soaking the negative electrode in a DMC solution for 24 h. Subsequently, drying the negative electrode, scraping off a negative active material layer from the dried negative electrode, oven-drying the negative active material layer, and then grinding the negative active material layer into powder. Taking 6 parallel specimens of the negative active material layer powder, weighing, digesting, and diluting the specimens, and then determining the mass percent of different metal elements by using an inductively coupled plasma-optical emission spectrometer (model: Thermo ICAP6300). Averaging out the measured values of the six parallel specimens. The mass percent of each metal element is a mass percent in the negative active material layer.

### Testing the Porosity α of the Negative Active Material Layer

Die-cutting a negative electrode to obtain a disc specimen of a radius d. Measuring the thickness h₁ of the negative electrode specimen with a ten-thousandth micrometer. Putting the specimen into a specimen chamber of an AccuPyc 1340 instrument. Filling the negative electrode specimen with helium (He) in the airtight specimen chamber to obtain a true volume V of the specimen based on the Bohr's law PV=nRT. After completion of determining the true volume of the negative electrode, washing off the negative active material layer from the surface of the negative electrode, and measuring the thickness of the current collector by using a ten-thousandth micrometer, denoting the thickness as h₂, and calculating the apparent volume of the negative active material layer as: apparent volume=πd²×(h₁−h₂). Finally, calculating the porosity α of the negative active material layer as: α=1−(V−πd²×h₂)/[πd²×(h₁−h₂)].

### Testing the Areal Density of a Negative Active Material Layer on a Single Side

1) Taking a negative electrode coated with a negative active material layer on a single side, cutting the negative electrode into a square specimen of 10 cm×10 cm in size, measuring the weight of the specimen, and recording the weight as M₁.
2) Cleaning the negative electrode with deionized water to remove the negative active material layer, oven-drying negative electrode, measuring the weight of the current collector, and recording the weight as M₂; and
3) The areal density on a single side is (M₁−M₂)/(10 cm×10 cm).

### Thermogravimetric Analysis Test

Taking 10 mg of negative active material layer as a specimen, and placing the specimen in a thermogravimetric analyzer, where the test atmosphere is an air atmosphere, the test temperatures ranges from 20° C. to 800° C., and heating rate is 5° C./min.

After completion of the thermogravimetric analysis, recording a weight loss of the specimen at a temperature of 400° C. and 800° C., and calculating the weight loss percentage as: W_{T}%=100%−(weight loss percentage at 20° C. to 400° C.+ remaining mass percent).

### Testing the Contact Angle

Taking 10 ml of uniformly dispersed negative electrode slurry to serve as a specimen, and placing the negative electrode slurry specimen into a feeder of a contact angle tester according to an operation procedure of the contact angle tester. Cutting a 6 μm-thick copper foil into strips of 2 cm×4 cm in size, and placing a strip of copper foil onto a microscope slide, and placing the microscope slide on a lower side in the contact angle tester. Dripping the negative electrode slurry in the feeder onto the microscope slide, and dripping 3 μl to 5 μl each time. Photographing the dripped negative electrode slurry, and then performing fitting according to the requirements of the instrument, so as to obtain a result.

### Characterizing Cracks of the Negative Electrode

Placing a negative electrode coated with a negative active material layer in each embodiment and each comparative embodiment in a 120° C. oven (vacuum oven DZF-6030A), and baking the negative electrode for 10 min. Taking out the negative electrode, and leaving the negative electrode to stand at a room temperature for 25 min. Observing the cracking, and determining that no crack occurs if the appearance of the negative active material layer shows no cracks larger than 2 cm in length.

### Testing the Tensile Strength

Cutting the negative electrode in each embodiment and each comparative embodiment into strip specimens of 2 mm×10 mm in size, and fixing the strip specimen to the two ends of a GoTech tensile machine. Starting the GoTech tensile machine to stretch the strip specimen. Recording the data when the strip specimen snaps off.

### Testing the Discharge Capacity

Setting the lithium-ion battery in each embodiment and each comparative embodiment in accordance with the rated capacity and operating voltage range of the lithium-ion battery (assuming that the rated capacity is Co and the operating voltage range is 3 V to 4.4V).

Placing the lithium-ion battery in a 25° C. constant-temperature environment. Leaving the lithium-ion battery to stand for 30 min, and then discharging the battery at a current of 0.2C (current=0.2×C₀) until the voltage reaches 3.0 V, and then leaving the battery to stand for 10 min. Charging the lithium-ion battery at a current of 0.2×C₀ until the voltage reaches 4.4 V, and then charging the battery at a constant voltage of 4.4 V until the current drops to 0.05 C (current=0.05×C₀). Leaving the battery to stand for 10 min, and then discharging the lithium-ion battery again at a current of 0.2C (current=0.2×C₀) until the voltage reaches 3.0 V to obtain a discharge capacity of this application.

### Embodiment 1-1

### <Preparing a Positive Electrode>

Mixing LiCoO₂ as a positive active material, acetylene black, and PVDF at a mass ratio of 96.5:2:1.5. Adding N-methyl-pyrrolidone (NMP) as a solvent to produce a slurry in which the solid content is 75%. Stirring the mixed system with a vacuum mixer until the system becomes a homogeneous positive electrode slurry. Applying the positive electrode slurry evenly onto one surface of a 10 μm-thick positive current collector aluminum foil, and oven-drying the slurry at 90° C. to obtain a positive electrode coated with a 110 μm-thick positive active material layer on a single side. Subsequently, repeating the above steps on the other surface of the positive electrode to obtain a positive electrode coated with a positive active material layer on both sides. Performing oven-drying at 90° C., and then performing cold-pressing, cutting, and tab welding to obtain a positive electrode.

### <Preparing a Negative Electrode>

Mixing graphite, sodium hydroxymethyl cellulose, and SBR at a mass ratio of 97:1:2, stirring well, adding deionized water and an additive stearamide, and dispersing the mixture at a high speed at a temperature of 35° C. to produce a well-dispersed negative electrode slurry in which the solid content is 70%. Applying the negative electrode slurry evenly onto one surface of a 6 μm-thick negative current collector copper foil, and drying the slurry at 90° C. to obtain a negative electrode coated with a 130 μm-thick negative active material layer on a single side. Subsequently, repeating the above steps on the other surface of the negative electrode to obtain a negative electrode coated with a negative active material layer on both sides. Performing oven-drying at 90° C., and then performing cold-pressing, cutting, and tab welding to obtain a negative electrode. Based on the mass of the negative active material layer, the mass percent of the additive stearamide is 0.5%, and the aggregate mass percent of graphite, sodium hydroxymethyl cellulose, and SBR is 99.5%. The porosity α of the negative active material layer is 40%, and the areal density of the negative active material layer on a single side is 0.13 mg/mm².

### <Preparing a Separator>

Using a 14 μm-thick polyethylene porous polymer film as a separator.

### <Preparing an Electrolyte Solution>

Mixing EC, PC, EMC, and DEC at a mass ratio of 20:20:40:20 in an dry argon atmosphere to obtain an organic solvent, and then adding fluoroethylene carbonate and lithium hexafluorophosphate into the organic solvent to dissolve, and stirring well. Based on the total mass of the electrolyte solution, the mass percent of the lithium hexafluorophosphate is 12%, the mass percent of the fluoroethylene carbonate is 2%, and the remainder is the organic solvent.

### <Preparing a Lithium-Ion Battery>

Stacking the prepared positive electrode, the separator, and the negative electrode sequentially in such a way that the separator is located between the positive electrode and the negative electrode to serve a function of separation, and winding the stacked structure to obtain an electrode assembly. Putting the electrode assembly into an aluminum laminated film packaging shell, dehydrating the packaged electrode assembly in an 85° C. vacuum oven for 12 hours, and then injecting the prepared electrolyte solution. Performing steps such as vacuum sealing, standing, chemical formation, degassing, and shaping to obtain a lithium-ion battery.

### Embodiments 1-2 to 1-13

Identical to Embodiment 1-1 except that the relevant preparation parameters are adjusted according to Table 1.

### Embodiments 2-1 to 2-23

Identical to Embodiment 1-1 except that the relevant preparation parameters are adjusted according to Table 2, and the metal elements shown in Table 2 are added into the additive, for example, an appropriate amount of magnesium chloride, aluminum chloride, and dicobalt trioxide is added into the additive during production of the additive, so that the content of the metal element in the negative active material layer complies with Table 2.

### Embodiments 3-1 to 3-5

Identical to Embodiment 1-1 except that the relevant constituents and content thereof are adjusted according to Table 3, and the mass percentages of graphite and SBR are changed accordingly to ensure that the mass ratio between the graphite and the SBR is 97:2.

### Embodiments 4-1 to 4-8

Identical to Embodiment 1-1 except that the relevant preparation parameters are adjusted according to Table 4.

### Comparative Embodiments 1 to 2

Identical to Embodiment 1-1 except that the relevant preparation parameters are adjusted according to Table 1.

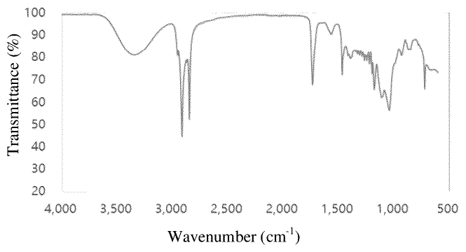

FIGURE shows an infrared spectrogram according to Embodiment 2-1. As can be seen from FIG. 1, there are three peaks in the wavenumber range of 2500 cm⁻¹ to 3200 cm⁻¹, indicating that the negative active material layer in Embodiment 2-1 contains a substance that exhibits at least a first peak and a second peak in the wavenumber range of 2500 cm⁻¹ to 3200 cm⁻¹.

Table 1 to Table 4 show the preparation parameters and performance parameters of each embodiment and each comparative embodiment.

TABLE 1

| | Additive | | First peak | | Second peak | |
|---|---|---|---|---|---|---|
| | | Content | | Intensity | | Intensity |
| | | W₁ | Wavenumber | ε₁ | Wavenumber | ε₂ |
| | Type | (%) | (cm⁻¹) | (T %) | (cm⁻¹) | (%) |
| Embodiment | Stearamide | 0.5 | 2848 | 48 | 2915 | 51 |
| 1-1 | | | | | | |
| Embodiment | Magnesium | 0.5 | 2853 | 50 | 2920 | 56 |
| 1-2 | stearate | | | | | |
| Embodiment | Stearamide | 0.6 | 2848 | 45 | 2915 | 47 |
| 1-3 | | | | | | |
| Embodiment | Magnesium | 0.6 | 2853 | 48 | 2920 | 53 |
| 1-4 | stearate | | | | | |
| Embodiment | Stearamide | 0.1 | 2848 | 56 | 2915 | 60 |
| 1-5 | | | | | | |
| Embodiment | Stearamide | 0.3 | 2848 | 53 | 2915 | 57 |
| 1-6 | | | | | | |
| Embodiment | Stearamide | 5 | 2848 | 18 | 2915 | 18 |
| 1-7 | | | | | | |
| Embodiment | Magnesium | 0.05 | 2853 | 70 | 2920 | 96 |
| 1-8 | stearate | | | | | |
| Embodiment | Magnesium | 0.1 | 2853 | 60 | 2920 | 80 |
| 1-9 | stearate | | | | | |
| Embodiment | Magnesium | 0.3 | 2853 | 55 | 2920 | 69 |
| 1-10 | stearate | | | | | |
| Embodiment | Magnesium | 1 | 2853 | 22 | 2920 | 23 |
| 1-11 | stearate | | | | | |
| Embodiment | Magnesium | 2 | 2853 | 21 | 2920 | 22 |
| 1-12 | stearate | | | | | |
| Embodiment | Magnesium | 3 | 2853 | 20 | 2920 | 20 |
| 1-13 | stearate | | | | | |
| Comparative | \ | \ | \ | \ | \ | \ |
| Embodiment | | | | | | |
| 1 | | | | | | |
| Comparative | Ethyl | 1 | \ | \ | \ | \ |
| Embodiment | acetate | | | | | |
| 2 | | | | | | |

| | | | | Number | | | Weight loss |
|---|---|---|---|---|---|---|---|
| | | Contact | | of | Tensile | Discharge | percentage |
| | | angle | Cracking | cracks | strength | capacity | W_{T} |
| | ε₁/ε₂ | (°) | status | (pcs) | (MPa) | (mAh) | (%) |
| Embodiment | 0.95 | 25 | No | \ | 500 | 600 | 0.5 |
| 1-1 | | | crack | | | | |
| Embodiment | 0.9 | 28 | No | \ | 480 | 603 | 0.5 |
| 1-2 | | | crack | | | | |
| Embodiment | 0.95 | 20 | No | \ | 550 | 593 | 0.6 |
| 1-3 | | | crack | | | | |
| Embodiment | 0.9 | 22 | No | \ | 520 | 595 | 0.6 |
| 1-4 | | | crack | | | | |
| Embodiment | 0.93 | 42 | No | \ | 492 | 612 | 0.1 |
| 1-5 | | | crack | | | | |
| Embodiment | 0.93 | 37 | No | \ | 497 | 608 | 0.3 |
| 1-6 | | | crack | | | | |
| Embodiment | 1.0 | 10 | No | \ | 580 | 550 | 5 |
| 1-7 | | | crack | | | | |
| Embodiment | 0.73 | 50 | Cracked | 2 | 450 | 610 | 0.05 |
| 1-8 | | | | | | | |
| Embodiment | 0.75 | 45 | Cracked | 1 | 465 | 610 | 0.1 |
| 1-9 | | | | | | | |
| Embodiment | 0.8 | 40 | Cracked | 1 | 470 | 607 | 0.3 |
| 1-10 | | | | | | | |
| Embodiment | 0.96 | 18 | No | \ | 560 | 590 | 1 |
| 1-11 | | | crack | | | | |
| Embodiment | 0.97 | 14 | No | \ | 572 | 570 | 2 |
| 1-12 | | | crack | | | | |
| Embodiment | 0.98 | 10 | No | \ | 578 | 560 | 3 |
| 1-13 | | | crack | | | | |
| Comparative | \ | 72 | Cracked | 5 | 450 | 540 | \ |
| Embodiment | | | | | | | |
| 1 | | | | | | | |
| Comparative | \ | 72 | Cracked | 6 | 460 | 545 | 1 |
| Embodiment | | | | | | | |
| 2 | | | | | | | |

Note:
“\” in Table 1 indicates absence of the relevant parameter.

As can be seen from Embodiments 1-1 to 1-13 and Comparative Embodiments 1 to 2, when the negative active material layer contains a substance that exhibits at least a first peak and a second peak in a wavenumber range of 2500 cm⁻¹ to 3200 cm⁻¹, the tensile strength of the negative electrode is increased, the risk of cracking the negative active material layer is reduced, the processability of the negative electrode is improved, and the resulting lithium-ion battery exhibits a high discharge capacity. Therefore, the production efficiency of the lithium-ion battery is improved on the basis of achieving a high discharge capacity of the lithium-ion battery. When 0.9≤ε₁/ε₂≤1.0, the overall performance of the lithium-ion battery cell is higher. As can be seen from Embodiments 1-2, 1-4, and 1-8 to 1-13, when the mass percent W₁% of the additive in the negative active material layer falls with the range specified herein, the lithium-ion battery exhibits a high discharge capacity and a relatively high production efficiency.

TABLE 2

| | Additive | | | | | | | | |
|---|---|---|---|---|---|---|---|---|---|
| | | Content | Type of | Content of metal element | | | | | |
| | | W₁ | metal | M₁ | M₂ | M₃ | | | M |
| | Type | (%) | element | (ppm) | (ppm) | (ppm) | M₁/M₂ | M₁/M₃ | (ppm) |
| Embodiment | Stearamide | 0.5 | \ | \ | \ | \ | \ | \ | \ |
| 1-1 | | | | | | | | | |
| Embodiment | Magnesium | 0.5 | Mg | \ | \ | \ | \ | \ | 15 |
| 2-1 | stearate | | | | | | | | |
| Embodiment | Stearamide | 0.5 | Al | 20 | \ | \ | \ | \ | 20 |
| 2-2 | | | | | | | | | |
| Embodiment | Stearamide | 0.5 | Al | 50 | \ | \ | \ | \ | 50 |
| 2-3 | | | | | | | | | |
| Embodiment | Aluminum | 0.5 | Al | 90 | \ | \ | \ | \ | 90 |
| 2-4 | stearate | | | | | | | | |
| Embodiment | Stearamide | 0.5 | Co | \ | 1 | \ | \ | \ | 1 |
| 2-5 | | | | | | | | | |
| Embodiment | Stearamide | 0.5 | Co | \ | 5 | \ | \ | \ | 5 |
| 2-6 | | | | | | | | | |
| Embodiment | Stearamide | 0.5 | Co | \ | 10 | \ | \ | \ | 10 |
| 2-7 | | | | | | | | | |
| Embodiment | Stearamide | 0.5 | Co | \ | 20 | \ | \ | \ | 20 |
| 2-8 | | | | | | | | | |
| Embodiment | Stearamide | 0.5 | Cr | \ | \ | 0.1 | \ | \ | 0.1 |
| 2-9 | | | | | | | | | |
| Embodiment | Stearamide | 0.5 | Cr | \ | \ | 2 | \ | \ | 2 |
| 2-10 | | | | | | | | | |
| Embodiment | Stearamide | 0.5 | Cr | \ | \ | 5 | \ | \ | 5 |
| 2-11 | | | | | | | | | |
| Embodiment | Stearamide | 0.5 | Al + Co | 5 | 1 | \ | 5 | \ | 6 |
| 2-12 | | | | | | | | | |
| Embodiment | Stearamide | 0.5 | Al + Co | 150 | 5 | \ | 30 | \ | 155 |
| 2-13 | | | | | | | | | |
| Embodiment | Aluminum | 0.5 | Al + Co | 360 | 6 | \ | 60 | \ | 366 |
| 2-14 | stearate | | | | | | | | |
| Embodiment | Stearamide | 0.5 | Al + Cr | 150 | \ | 5 | \ | 30 | 155 |
| 2-15 | | | | | | | | | |
| Embodiment | Aluminum | 0.5 | Al + Cr | 90 | \ | 1.5 | \ | 60 | 91.5 |
| 2-16 | stearate | | | | | | | | |
| Embodiment | Aluminum | 0.5 | Al + Cr | 60 | \ | 0.6 | \ | 100 | 60.6 |
| 2-17 | stearate | | | | | | | | |
| Embodiment | Aluminum | 0.5 | Al + Cr | 55 | \ | 0.8 | \ | 69 | 55.8 |
| 2-18 | stearate | | | | | | | | |
| Embodiment | Stearamide | 0.5 | Al + Co + Cr | 65 | 5 | 1 | 13 | 65 | 71 |
| 2-19 | | | | | | | | | |
| Embodiment | Stearamide | 0.5 | Al + Co + Cr | 40 | 3 | 0.7 | 13 | 57 | 43.7 |
| 2-20 | | | | | | | | | |
| Embodiment | Stearamide | 0.5 | Al + Co + Cr | 70 | 6 | 1.2 | 12 | 58 | 77.2 |
| 2-21 | | | | | | | | | |
| Embodiment | Stearamide | 0.5 | Al + Co + Cr | 70 | 6 | 0.6 | 12 | 117 | 76.6 |
| 2-22 | | | | | | | | | |
| Embodiment | Stearamide | 0.5 | Al + Co + Cr | 120 | 12 | 0.6 | 10 | 200 | 132.6 |
| 2-23 | | | | | | | | | |

| | | | Number | | | Weight loss |
|---|---|---|---|---|---|---|
| | Contact | | of | Tensile | Discharge | percentage |
| | angle | Cracking | cracks | strength | capacity | W_{T} |
| | (°) | status | (pcs) | (MPa) | (mAh) | (%) |
| Embodiment | 25 | No | \ | 500 | 600 | 0.5 |
| 1-1 | | crack | | | | |
| Embodiment | 23 | No | \ | 510 | 604 | 0.5 |
| 2-1 | | crack | | | | |
| Embodiment | 24 | No | \ | 520 | 607 | 0.5 |
| 2-2 | | crack | | | | |
| Embodiment | 24 | No | \ | 522 | 605 | 0.5 |
| 2-3 | | crack | | | | |
| Embodiment | 26 | No | \ | 498 | 598 | 0.5 |
| 2-4 | | crack | | | | |
| Embodiment | 23 | No | \ | 507 | 601 | 0.5 |
| 2-5 | | crack | | | | |
| Embodiment | 22 | No | \ | 530 | 605 | 0.5 |
| 2-6 | | crack | | | | |
| Embodiment | 25 | No | \ | 512 | 603 | 0.5 |
| 2-7 | | crack | | | | |
| Embodiment | 26 | No | \ | 504 | 602 | 0.5 |
| 2-8 | | crack | | | | |
| Embodiment | 24 | No | \ | 507 | 604 | 0.5 |
| 2-9 | | crack | | | | |
| Embodiment | 24 | No | \ | 520 | 603 | 0.5 |
| 2-10 | | crack | | | | |
| Embodiment | 25 | No | \ | 500 | 590 | 0.5 |
| 2-11 | | crack | | | | |
| Embodiment | 23 | No | \ | 514 | 605 | 0.5 |
| 2-12 | | crack | | | | |
| Embodiment | 22 | No | \ | 530 | 596 | 0.5 |
| 2-13 | | crack | | | | |
| Embodiment | 21 | No | \ | 514 | 574 | 0.5 |
| 2-14 | | crack | | | | |
| Embodiment | 24 | No | \ | 520 | 585 | 0.5 |
| 2-15 | | crack | | | | |
| Embodiment | 25 | No | \ | 520 | 606 | 0.5 |
| 2-16 | | crack | | | | |
| Embodiment | 23 | No | \ | 525 | 607 | 0.5 |
| 2-17 | | crack | | | | |
| Embodiment | 23 | No | \ | 527 | 609 | 0.5 |
| 2-18 | | crack | | | | |
| Embodiment | 23 | No | \ | 530 | 610 | 0.5 |
| 2-19 | | crack | | | | |
| Embodiment | 25 | No | \ | 531 | 612 | 0.5 |
| 2-20 | | crack | | | | |
| Embodiment | 23 | No | \ | 535 | 607 | 0.5 |
| 2-21 | | crack | | | | |
| Embodiment | 23 | No | \ | 529 | 604 | 0.5 |
| 2-22 | | crack | | | | |
| Embodiment | 22 | No | \ | 524 | 587 | 0.5 |
| 2-23 | | crack | | | | |

Note:
“\” in Table 2 indicates absence of the relevant parameter.

The type and content of the metal elements in the negative active material layer usually also affect the discharge capacity and production efficiency of the lithium-ion battery. As can be seen from Embodiment 1-1 and Embodiments 2-1 to 2-23, when the type and content of the metal elements in the negative active material layer fall with the ranges specified herein, the lithium-ion battery exhibits a high discharge capacity and a relatively high production efficiency.

When the negative active material layer includes Al, the content of Al usually also affects the discharge capacity and production efficiency of the lithium-ion battery. As can be seen from Embodiments 2-2 to 2-4, when the content of Al falls with the range specified herein, the lithium-ion battery exhibits a high discharge capacity and a relatively high production efficiency.

When the negative active material layer includes Co, the content of Co usually also affects the discharge capacity and production efficiency of the lithium-ion battery. As can be seen from Embodiments 2-5 to 2-8, when the content of Co falls with the range specified herein, the lithium-ion battery exhibits a high discharge capacity and a relatively high production efficiency.

When the negative active material layer includes Cr, the content of Cr usually also affects the discharge capacity and production efficiency of the lithium-ion battery. As can be seen from Embodiments 2-9 to 2-11, when the content of Cr falls with the range specified herein, the lithium-ion battery exhibits a high discharge capacity and a relatively high production efficiency.

When the negative active material layer includes Al and Co, the ratio of the content of Al to the content of Co, denoted as M₁/M₂, usually also affects the discharge capacity and production efficiency of the lithium-ion battery. As can be seen from Embodiments 2-12 to 2-14, when the ratio of the content of Al to the content of Co, denoted as M₁/M₂, falls with the range specified herein, the lithium-ion battery exhibits a high discharge capacity and a relatively high production efficiency.

When the negative active material layer includes Al and Cr, the ratio of the content of Al to the content of Cr, denoted as M₁/M₃, usually also affects the discharge capacity and production efficiency of the lithium-ion battery. As can be seen from Embodiments 2-15 to 2-18, when the ratio of the content of Al to the content of Cr, denoted as M₁/M₃, falls with the range specified herein, the lithium-ion battery exhibits a high discharge capacity and a relatively high production efficiency.

When the negative active material layer includes Al, Co, and Cr, the ratio of the content of Al to the content of Co, denoted as M₁/M₂, and the ratio of the content of Al to the content of Cr, denoted as M₁/M₃, usually also affect the discharge capacity and production efficiency of the lithium-ion battery. As can be seen from Embodiments 2-19 to 2-23, when the ratio of the content of Al to the content of Cr, denoted as M₁/M₃, falls with the range specified herein, the lithium-ion battery exhibits a high discharge capacity and a relatively high production efficiency.

TABLE 3

| | Additive | | Dispersant | | | Contact | | Number | Tensile | Discharge | Weight loss |
|---|---|---|---|---|---|---|---|---|---|---|---|
| | | Content | | Content | W₂ − W₁ | angle | Cracking | of | strength | capacity | percentage |
| | Type | W₁ (%) | Type | W₂ (%) | (%) | (°) | status | cracks | (MPa) | (mAh) | W_{T} (%) |
| Embodiment | Stearamide | 0.5 | Sodium | 1 | 0.5 | 25 | No | 1 | 500 | 600 | 0.5 |
| 1-1 | | | hydroxymethyl | | | | crack | | | | |
| | | | cellulose | | | | | | | | |
| Embodiment | Stearamide | 0.5 | Lithium | 1 | 0.5 | 28 | No | 1 | 501 | 607 | 0.5 |
| 3-1 | | | hydroxymethyl | | | | crack | | | | |
| | | | cellulose | | | | | | | | |
| Embodiment | Stearamide | 0.5 | Polyacrylic | 1 | 0.5 | 30 | Cracked | 1 | 493 | 594 | 0.5 |
| 3-2 | | | acid | | | | | | | | |
| Embodiment | Stearamide | 1 | Sodium | 1 | 0 | 10 | No | 1 | 550 | 590 | 1 |
| 3-3 | | | hydroxymethyl | | | | crack | | | | |
| | | | cellulose | | | | | | | | |
| Embodiment | Stearamide | 0.1 | Sodium | 3 | 2.9 | 28 | No | 1 | 450 | 620 | 0.1 |
| 3-4 | | | hydroxymethyl | | | | crack | | | | |
| | | | cellulose | | | | | | | | |
| Embodiment | Stearamide | 0.5 | Lithium | 0.5 | 0 | 28 | No | 1 | 487 | 598 | 0.5 |
| 3-5 | | | hydroxymethyl | | | | crack | | | | |
| | | | cellulose | | | | | | | | |

Note:
“\” in Table 3 indicates absence of the relevant parameter.

The type of the dispersant usually also affects the discharge capacity and production efficiency of the lithium-ion battery. As can be seen from Embodiment 1-1 and Embodiments 3-1 to 3-5, when the type of the dispersant falls with the range specified herein, the lithium-ion battery exhibits a high discharge capacity and a relatively high production efficiency.

The difference between the content W₂ of the dispersant and the content W₁ of the additive, denoted as W₂−W₁, usually also affects the discharge capacity and production efficiency of the lithium-ion battery. As can be seen from Embodiment 1-1 and Embodiments 3-3 to 3-4, when the difference between the content W₂ of the dispersant and the content W₁ of the additive, denoted as W₂−W₁, falls with the range specified herein, the lithium-ion battery exhibits a high discharge capacity and a relatively high production efficiency.

TABLE 4

| | | Single-side | Type of | | | Number | | |
|---|---|---|---|---|---|---|---|---|
| | Porosity | areal | negative | Contact | | of | Tensile | Discharge |
| | α | density | active | angle | Cracking | cracks | strength | capacity |
| | (%) | (mg/mm²) | material | (°) | status | (pcs) | (MPa) | (mAh) |
| Embodiment 1-1 | 40 | 0.13 | Graphite | 25 | No crack | 1 | 500 | 600 |
| Embodiment 4-1 | 15 | 0.13 | Graphite | 25 | No crack | 1 | 507 | 593 |
| Embodiment 4-2 | 25 | 0.13 | Graphite | 25 | No crack | 1 | 506 | 604 |
| Embodiment 4-3 | 50 | 0.13 | Graphite | 25 | No crack | 1 | 498 | 599 |
| Embodiment 4-4 | 70 | 0.13 | Graphite | 25 | No crack | 1 | 495 | 583 |
| Embodiment 4-5 | 40 | 0.02 | Graphite | 25 | No crack | 1 | 400 | 592 |
| Embodiment 4-6 | 40 | 0.3 | Graphite | 25 | No crack | 1 | 550 | 1384 |
| Embodiment 4-7 | 40 | 0.4 | Graphite | 25 | No crack | 1 | 570 | 1846 |
| Embodiment 4-8 | 40 | 0.13 | Silicon | 40 | Cracked | 1 | 380 | 800 |

Note:
“\” in Table 4 indicates absence of the relevant parameter.

The porosity α of the negative active material layer usually also affects the discharge capacity and production efficiency of the lithium-ion battery. As can be seen from Embodiment 1-1 and Embodiments 4-1 to 4-4, when the porosity α of the negative active material layer falls with the range specified herein, the lithium-ion battery exhibits a high discharge capacity and a relatively high production efficiency.

The areal density of the negative active material layer on a single side usually also affects the discharge capacity and production efficiency of the lithium-ion battery. As can be seen from Embodiment 1-1 and Embodiments 4-5 to 4-8, when the areal density of the negative active material layer on a single side falls with the range specified herein, the lithium-ion battery exhibits a high discharge capacity and a relatively high production efficiency.

The type of the negative active material usually also affects the discharge capacity of the lithium-ion battery. As can be seen from Embodiments 1-1 and 4-8, when the type of the negative active material falls with the range specified herein, the lithium-ion battery exhibits a high discharge capacity.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. An electrochemical device, comprising a negative electrode, wherein the negative electrode comprises a negative current collector and a negative active material layer disposed on at least one surface of the negative current collector; and
in an infrared spectroscopy test, the negative active material layer exhibits at least a first peak and a second peak in a wavenumber range of 2500 cm⁻¹ to 3200 cm⁻¹.

2. The electrochemical device according to claim 1, wherein the first peak corresponds to a wavenumber k₁ falling within a range of 2800 cm⁻¹≤k₁≤2900 cm⁻¹, the second peak corresponds to a wavenumber k₂ falling within a range of 2900 cm⁻¹≤k₂≤3000 cm⁻¹; and 0.9≤ε₁/ε₂≤1.0, wherein Pi is an intensity of the first peak and ε₂ is an intensity of the second peak.

3. The electrochemical device according to claim 1, wherein the negative active material layer comprises an additive; and the additive comprises at least one of stearic acid, stearamide, magnesium stearate, calcium stearate, sodium stearate, lithium stearate, zinc stearate, aluminum stearate, chromium stearate, or barium stearate.

4. The electrochemical device according to claim 3, wherein, based on a mass of the negative active material layer, a mass percent W₁% of the additive is 0.05% to 5%.

5. The electrochemical device according to claim 1, wherein the negative active material layer comprises a metal element; and the metal element comprises at least one of Mg, Al, Co, Ti, Cr, Y, W, or Ca.

6. The electrochemical device according to claim 5, wherein, based on a mass of the negative active material layer, a content of the metal element is M ppm, M≤300.

7. The electrochemical device according to claim 5, wherein the metal element satisfies at least one of the following features (a) to (e):
(a) the metal element comprises Al, and, based on a mass of the negative active material layer, a content of Al is M₁ ppm, 10≤M₁≤90;
(b) the metal element comprises Co, and, based on a mass of the negative active material layer, a content of Co is M₂ ppm, 0.5≤M₂≤20;
(c) the metal element comprises Cr, and, based on a mass of the negative active material layer, a content of Cr is M₃ ppm, 0≤M₃≤5;
(d) the metal element comprises Al and Co, and, based on a mass of the negative active material layer, a content of Al is M₁ ppm, and a content of Co is M₂ ppm, 5≤M₁/M₂≤60, and 1≤M₂≤20; or
(e) the metal element comprises Al and Cr, and, based on a mass of the negative active material layer, a content of Al is M₁ ppm, and a content of Cr is M₃ ppm, 30≤M₁/M₃≤100.

8. The electrochemical device according to claim 3, wherein the negative active material layer further comprises a dispersant; and the dispersant comprises at least one of lithium hydroxymethyl cellulose, sodium hydroxymethyl cellulose, polyacrylic acid, or sodium polyacrylate; and
based on a mass of the negative active material layer, a mass percent W₂% of the dispersant and a mass percent W₁% of the additive satisfy: 0≤W₂−W₁≤3.

9. The electrochemical device according to claim 1, wherein the negative active material layer satisfies at least one of the following conditions:
(I) a porosity α of the negative active material layer is 15% to 60%;
(II) an areal density of the negative active material layer on a single side is 0.02 mg/mm² to 0.4 mg/mm²;
(III) in a thermogravimetric analysis, a weight loss percentage of the negative active material layer in a temperature range of 400° C. to 800° C. is W_{T}%, and W_{T}≤1; or
(IV) the negative active material layer further comprises a negative active material, and the negative active material comprises at least one of graphite, hard carbon, silicon, or a silicon-oxygen material.

10. The electrochemical device according to claim 1, wherein a number of cracks in any region of 20 cm×40 cm in size selected on the negative active material layer is less than or equal to 2.

11. The electrochemical device according to claim 1, wherein a tensile strength of the negative electrode is 300 MPa to 600 MPa.

12. An electronic device, comprising the electrochemical device according to claim 1.

13. The electronic device according to claim 12, wherein the first peak corresponds to a wavenumber k₁ falling within a range of 2800 cm⁻¹≤k₁≤2900 cm⁻¹, the second peak corresponds to a wavenumber k₂ falling within a range of 2900 cm⁻¹≤k₂≤3000 cm⁻¹; and 0.9≤ε₁/ε₂≤1.0, wherein ε₁ is an intensity of the first peak and ε₂ is an intensity of the second peak.

14. The electronic device according to claim 12, wherein the negative active material layer comprises an additive; and the additive comprises at least one of stearic acid, stearamide, magnesium stearate, calcium stearate, sodium stearate, lithium stearate, zinc stearate, aluminum stearate, chromium stearate, or barium stearate.

15. The electronic device according to claim 14, wherein, based on a mass of the negative active material layer, a mass percent W₁% of the additive is 0.05% to 5%.

16. The electronic device according to claim 12, wherein the negative active material layer comprises a metal element; and the metal element comprises at least one of Mg, Al, Co, Ti, Cr, Y, W, or Ca.

17. The electronic device according to claim 16, wherein, based on a mass of the negative active material layer, a content of the metal element is M ppm, M≤300.

18. The electronic device according to claim 16, wherein the metal element satisfies at least one of the following features (a) to (e):
(a) the metal element comprises Al, and, based on a mass of the negative active material layer, a content of Al is M₁ ppm, 10≤M₁≤90;
(b) the metal element comprises Co, and, based on a mass of the negative active material layer, a content of Co is M₂ ppm, 0.5≤M₂≤20;
(c) the metal element comprises Cr, and, based on a mass of the negative active material layer, a content of Cr is M₃ ppm, 0≤M₃≤5;
(d) the metal element comprises Al and Co, and, based on a mass of the negative active material layer, a content of Al is M₁ ppm, and a content of Co is M₂ ppm, 5≤M₁/M₂≤60, and 1≤M₂≤20; or
(e) the metal element comprises Al and Cr, and, based on a mass of the negative active material layer, a content of Al is M₁ ppm, and a content of Cr is M₃ ppm, 30≤M₁/M₃≤100.

19. The electronic device according to claim 14, wherein the negative active material layer further comprises a dispersant, and the dispersant comprises at least one of lithium hydroxymethyl cellulose, sodium hydroxymethyl cellulose, polyacrylic acid, or sodium polyacrylate; and
based on a mass of the negative active material layer, a mass percent W₂% of the dispersant and a mass percent W₁% of the additive, 0≤W₂−W₁≤3.

20. The electronic device according to claim 12, wherein the negative active material layer satisfies at least one of the following conditions:
(I) a porosity α of the negative active material layer is 15% to 60%;
(II) an areal density of the negative active material layer on a single side is 0.02 mg/mm² to 0.4 mg/mm²;
(III) in a thermogravimetric analysis, a weight loss percentage of the negative active material layer in a temperature range of 400° C. to 800° C. is W_{T}%, and W_{T}≤1; or
(IV) the negative active material layer further comprises a negative active material, and the negative active material comprises at least one of graphite, hard carbon, silicon, or a silicon-oxygen material.
